(19) United States
(12) Patent Application Publication
(10) Pub. No.: US 2025/0307002 A1
(43) Pub. Date: Oct. 2, 2025

(54) DYNAMIC RESOURCE MEMORY MANAGEMENT FOR NUMA GPUS

(71) Applicant: Advanced Micro Devices, Inc., Santa Clara, CA (US)

(72) Inventor: Travis Trapper Schluessler, Fort Collins, CO (US)

(73) Assignee: Advanced Micro Devices, Inc., Santa Clara, CA (US)

(21) Appl. No.: 18/621,518

(22) Filed: Mar. 29, 2024

(51) Int. Cl. G06F 9/50; G06F 12/02

(52) U.S. Cl. CPC G06F 9/5016; G06F 9/5038; G06F 12/0246; G06F 2212/2542

(57) ABSTRACT

A device and a method of analyzing execution of an application on a GPU NUMA device is provided. The device comprises a processor of a first type having a local memory portions and a plurality of processor sets sharing the plurality of local memory portions and configured to execute the application in units of execution. The device also comprises a processor of a second type configured to: issue commands to the processor of the first type to execute the application; identify a resource access pattern for each resource accessed in one or more of the local memory portions for a unit of execution; and map subsequently execute the application based on the identified access patterns.

### BACKGROUND

Accelerated processors are used to execute an application by processing a large amount of different tasks of the application in parallel with each other to speed up execution of the application. Accelerated processors are used to execute a wide range of applications types, such as graphics related applications, artificial intelligence applications, virtual reality applications.

### BRIEF DESCRIPTION OF THE DRAWINGS

A more detailed understanding can be had from the following description, given by way of example in conjunction with the accompanying drawings wherein:

FIG. 1 is a block diagram of an example computing device in which one or more features of the present disclosure can be implemented;

FIG. 2 is a block diagram of the computing device shown in FIG. 1, illustrating additional details related to execution of processing tasks on the accelerated processing device, according to an example;

FIG. 3 is a block diagram of the computing device shown in FIGS. 1 and 2, illustrating additional details related to execution of processing tasks on the accelerated processing device, according to an example;

FIG. 4 is a flow diagram illustrating an example method of analyzing execution of an application on a computing device comprising a GPU having a NUMA architecture according to features of the present disclosure;

FIG. 5 is a diagram showing an example of virtual address to physical address mapping for implementing features of the present disclosure;

FIG. 6 is a flow diagram illustrating an example method of analyzing execution of an application on computing device comprising a GPU having a NUMA architecture according to features of the present disclosure;

FIG. 7A is a flow diagram illustrating a method of storing resources in memory according to features of the present disclosure;

FIG. 7B is a flow diagram illustrating a method of identifying access patterns according to features of the present disclosure; and

FIG. 8 is a diagram illustrating an example network of computing devices each comprising a GPU having a NUMA architecture for implementing features of the present disclosure.

### DETAILED DESCRIPTION

As described herein, a page is a fixed-length, addressable contiguous region of memory. In the examples described herein, pages are used as a type of data unit for memory management. However, features of the present disclosure can be implemented using other types of data units for memory management.

As described herein, a physical page is the data representing a page in physical memory.

As described herein, a virtual page is the virtual address that references a physical page using a page address translation.

As described herein, a resource is any type of data (e.g., pixel data, texel data, or any other type of data including non-pixel data). A resource can be stored on a permanent storage device (e.g., a hard disk) or in memory (e.g., RAM). At compilation time, a resource is in memory or non-volatile memory or storage. At run-time, a resource is in memory. When a resource is in memory, the resource is in one or more pages. However, when a resource is in permanent storage, the resource is not in a page.

One example of an accelerated processor is a graphics processing unit (GPU) which is typically used for graphics and video rendering. For simplified explanation, a GPU is used as example of an accelerated processor in which one or more features of the present disclosure can be implemented. However, features of the present disclosure can be implemented using any accelerated processor or accelerated processing device which includes multiple processors which execute instructions in parallel (e.g., massively parallel processing) to speed up execution of the application.

Shared memory architecture includes uniform memory access (UMA), and non-uniform memory access (NUMA). In a UMA architecture, all processors have equal (i.e., uniform) access times to all portions of memory. In a NUMA architecture, each of a plurality of different sets of processors (e.g., compute units of a GPU, SIMD units of a compute unit or workgroup processors (WGPs)) have access to each portion of local memory. However, the access characteristics (e.g., memory access latency and memory bandwidth) for a processor set to some memory portions is different than the access characteristics for the processor set to other memory portions due to the differing amount of logic and lengths of connectivity between a processor and the different memory portions. That is, the memory access latency (i.e., a time from when a processor requests access to memory to a time when data in the portion of memory is returned) and the memory bandwidth for a processor (i.e., the rate at which data can be read from or written to memory) depends on the location of a portion of local memory relative to the processor.

Scaling high-end accelerated processors (e.g., GPUs) to higher computing and throughput capacities is facilitated by a NUMA architecture. NUMA architecture provides several advantages over UMA architecture. For example, each processor cluster has better access characteristics (e.g., memory access latency and memory bandwidth) to some memory portions. In a NUMA architecture, additional processors and shared memory portions can be added to more efficiently process intensive workloads because processors do not have to wait on other processors accessing memory over the same bus. Accordingly, a NUMA architecture can reduce memory access times and improve overall system performance.

However, in a NUMA architecture, because the access characteristics (e.g., the memory access latency and the memory bandwidth) for each processor set vary between different local memory portions, when memory access latency is longer or the memory bandwidth is reduced for a processor set to access one or more memory portions, the overall performance of a computing device is reduced.

Some conventional techniques used to reduce memory access latency and bandwidth include page replication, localized CPU work scheduling, and remote data caching. However, these techniques are not efficient for executing applications on a GPU with intensive workloads. For example, page replication includes creating copies of the same data (i.e., pages of data) to different portions of memory to facilitate accessing the data with the best access characteristics. However, if the pages are blindly replicated to different memory portions (e.g., 8 memory portions), memory utilization is also increased (e.g., by a factor of 8 if replicated to 8 memory portions). For example, assuming each memory portions includes 1 GB of memory (8 GB total), if an application needs 50% of the available memory (e.g., 4 GB of the total 8 GB) to execute, then blindly replicating the pages to each of the 8 memory portions would require 32 GB (i.e., 8×4 GB) of memory. That is, page replication results in oversubscribing the memory portions and, therefore, page replication is not possible in this case. Accordingly, page replication can improve performance, but at the cost of significantly increased memory usage and/or memory bandwidth and cannot improve performance after the memory portion with the lowest latency is oversubscribed.

Conventional local work scheduling for CPU workloads is not able to reduce memory access latency and bandwidth for GPU workloads. Conventional CPU local work scheduling utilizes conventional process and thread scheduling paradigms to place execution work and data together on CPU processor cores and their local memory. In the context of a GPU, these methods cannot work. GPUs have a different degree of parallel work execution than a CPU. For example, typical GPUs execute many work-items (i.e., threads), such as for example 8-64 work-items, concurrently (e.g., as a wavefront) on single instruction multiple data (SIMD) units of a compute unit. In contrast, while conventional CPU processing can include some processes in which multiple threads can pe processed in parallel, conventional CPU processing does not include local work scheduling for reducing the memory access latency for multiple work-items (i.e., threads) executing concurrently on a processor. Conventional local work scheduling cannot and does not: (1) identify the data needed by each of the concurrently executing threads; (2) ensure that the data is in a single local memory portion; or (3) ensure that each of the work-items run together on a single processor cluster, in a NUMA architecture, in which each processor of the cluster has the same memory access latency and bandwidth for a local memory portion.

Remote data caching can yield some performance benefits for GPU NUMA architectures. However, remote data caching includes significant cost of additional hardware resources. Additionally, because resources (e.g., data representing a portion of a frame) in remote portions of memory (e.g., memory portions farther from a particular set of processors than one or more other memory portions) still need to be copied into local portions of memory (e.g., memory portions closer to a particular set of processors than one or more other memory portions), remote data caching often does not provide the lowest latency accesses.

Features of the present disclosure improve performance of executing an application on a GPU having NUMA architecture (hereinafter “GPU NUMA device”) without application customization.

To determine an efficient execution of an application on a GPU NUMA device, a static analysis is performed during an first run of the application by individually analyzing GPU units of execution (e.g., work-items (i.e., threads), wavefronts, programs such as shader programs or other units of execution) used to execute the application, determining the resource access patterns (e.g., which portions of memory that include the resource are accessed by a processor set) for each unit of execution and mapping the resource access patterns between the processor sets and the local memory portions shared by the processor sets.

Based on the results of the static analysis (e.g., based on the mapped memory access patterns), work is scheduled for subsequent executions of the application on the GPU such that one or more of processor sets perform more frequent memory requests to the local memory portions with lower latency than memory requests to the local memory portions with higher latency. For example, the application is subsequently executed, based on the mapped access patterns, by scheduling a unit of execution on one or more processor sets of the GPU such that the one or more processor sets perform more frequent memory requests to the local memory portions closest to the one or more processor sets.

Features of the present disclosure analyze resource access patterns per discrete execution units (e.g., work-items (i.e., threads), wavefronts, shader programs, or other unit of execution on a GPU) at compilation time of an application and determine, based on the access patterns, in which memory portions to allocate the memory resources to efficiently execute the application. Features of the present disclosure analyze discrete GPU execution units for the application, identify and partition memory resources to different local memory portions, and schedule work to processor sets to reduce latency when accessing the resources.

A computing device for analyzing execution of an application is provided which comprises a processor of a first type configured to execute the application as units of execution and having a NUMA architecture comprising a plurality of local memory portions and a plurality of processor sets sharing the plurality of local memory portions. The computing device also comprises a processor of a second type configured to: issue commands to the processor of the first type to execute the application; identify a resource access pattern for each resource accessed in one or more of the local memory portions for a unit of execution; and map each resource to a physical address in one of the local memory portions. The application is subsequently executed based on the identified access patterns and the mapped resources.

A method of analyzing execution of an application on a computing device is provided which comprises: issuing, by a processor of a second type, commands to a processor of a first type having a NUMA architecture; identifying, by the processor of the second type, a resource access pattern for each resource to be accessed by the processor of a first type executing the application, in local memory portions shared by processor sets of the processor of the first type; and mapping each resource to a physical address in one of the local memory portions. The application is subsequently executed based on the identified access patterns and the mapped resources.

A system for analyzing execution of an application is provided which comprises a network and a plurality of computing devices in communication with each other via the network. Each of the plurality of computing devices comprises a processor of a first type having a NUMA architecture comprising a plurality of local memory portions and a plurality of processor sets sharing the plurality of local memory portions and configured to execute the application as units of execution. Each of the plurality of computing devices also comprises a processor of a second type configured to issue commands to the processor of the first type to execute the application; identify a resource access pattern for each resource accessed in one or more of the local memory portions for a unit of execution; and map each resource to a physical address in one of the local memory portions. The application is subsequently executed based on the identified access patterns and the mapped resources.

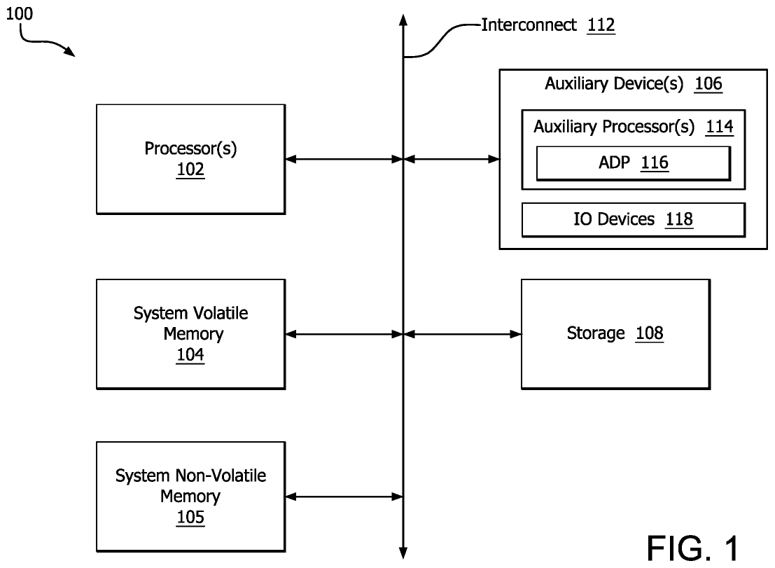

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory including system volatile memory 104 and system non-volatile memory 105, one or more auxiliary devices 106 and storage 108. An interconnect 112, which can be a bus, a combination of buses, and/or any other communication component, communicatively links the processor(s) 102, system volatile memory 104, system non-volatile memory 105, the auxiliary device(s) 106 and the storage 108.

In various alternatives, the processor(s) 102 include a central processing unit (CPU), a graphics processing unit (GPU), a CPU and GPU located on the same die, or one or more processor cores, wherein each processor core can be a CPU, a GPU, or a neural processor. In various alternatives, at least part of the system volatile memory 104 and system non-volatile memory 105 is located on the same die as one or more of the processor(s) 102, such as on the same chip or in an interposer arrangement, and/or at least part of system volatile memory 104 and system non-volatile memory 105 is located separately from the processor(s) 102. The system volatile memory 104 includes, for example, random access memory (RAM), dynamic RAM, or a cache. The system non-volatile memory 105 includes, for example, read only memory (ROM).

The storage 108 includes a fixed or removable storage, for example, without limitation, a hard disk drive, a solid state drive, an optical disk, or a flash drive. The auxiliary device(s) 106 include, without limitation, one or more auxiliary processors 114, and/or one or more input/output (“IO”) devices. The auxiliary processor(s) 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor. In some examples, the auxiliary processor(s) 114 include an accelerated processing device (“APD”) 116. In addition, although processor(s) 102 and APD 116 are shown separately in FIG. 1, in some examples, processor(s) 102 and APD 116 may be on the same chip.

The one or more IO devices 118 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display, a speaker, a printer, a haptic feedback device, one or more lights, an antenna, or a network connection (e.g., a wireless local area network card for transmission and/or reception of wireless IEEE 802 signals).

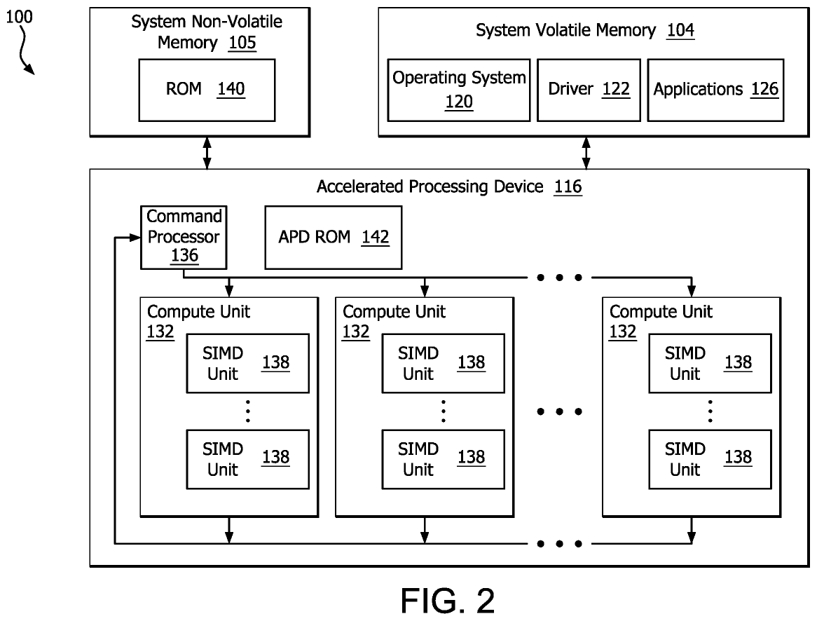

FIG. 2 is a block diagram of the computing device 100 shown in FIG. 1, illustrating additional details related to execution of processing tasks on the APD 116, according to an example.

The processor 102 maintains, in system volatile memory 104, one or more control logic modules for execution by the processor 102. The control logic modules include an operating system 120, drivers 122 (e.g., user mode driver and kernel mode driver), and applications 126, and may optionally include other modules not shown. These control logic modules control various aspects of the operation of the processor(s) 102 and the APD 116. For example, the operating system 120 directly communicates with hardware and provides an interface to the hardware for other software executing on the processor(s) 102. The drivers 122 controls operation of the APD 116 by, for example, providing an API to software (e.g., applications 126) executing on the processor(s) 102 to access various functionality of the APD 116. The drivers 122 also includes a just-in-time compiler that compiles shader code into shader programs for execution by processing components (such as the SIMD units 138 discussed in further detail below) of the APD 116. The processor 102 also includes non-volatile memory 105, such as for example, ROM 140. As shown in FIG. 2, APD 116 also includes APD ROM 142 as non-volatile memory.

The APD 116 executes commands and programs for selected functions, such as graphics operations and non-graphics operations, which may be suited for parallel processing. The APD 116 can be used for executing graphics pipeline operations such as pixel operations, geometric computations, and rendering an image to a display device (e.g., one of the IO devices 118) based on commands received from the processor(s) 102. The APD 116 also executes compute processing operations that are not directly related to graphics operations, based on commands received from the processor 102 or that are not part of the “normal” information flow of a graphics processing pipeline, or that are completely unrelated to graphics operations (sometimes referred to as “GPGPU” or “general purpose graphics processing unit”).

The APD 116 includes compute units 132 (which may collectively be referred to herein as “programmable processing units”) that include one or more SIMD units 138 that are configured to execute instructions to perform operations in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by individual lanes, predication of lanes corresponding to control flow paths not currently being executed, and serial execution of different control flow paths, allows for arbitrary control flow to be followed.

The basic unit of execution in compute units 132 is a work-item. Each work-item represents a single instantiation of a shader program that is to be executed in parallel in a particular lane of a wavefront. Work-items can be executed simultaneously as a “wavefront” on a single SIMD unit 138. Multiple wavefronts may be included in a “work group,” which includes a collection of work-items designated to execute the same program. A work group can be executed by executing each of the wavefronts that make up the work group. The wavefronts may be executed sequentially on a single SIMD unit 138 or partially or fully in parallel on different SIMD units 138. Wavefronts can be thought of as instances of parallel execution of a shader program, where each wavefront includes multiple work-items that execute simultaneously on a single SIMD unit 138 in line with the SIMD paradigm (e.g., one instruction control unit executing the same stream of instructions with multiple data). A command processor 137 is present in the compute units 132 and launches wavefronts based on work (e.g., execution tasks) that is waiting to be completed. A command processor 136 is configured to execute instructions to perform operations related to scheduling various wavefronts on different compute units 132 and SIMD units 138.

The parallelism afforded by the compute units 132 is suitable for graphics related operations such as pixel value calculations, vertex transformations, tessellation, geometry shading operations, and other graphics operations. A graphics processing pipeline 134 which accepts graphics processing commands from the processor(s) 102 thus provides computation tasks to the compute units 132 for execution in parallel.

The compute units 132 are also used to perform computation tasks not related to graphics or not performed as part of the operation of a graphics processing pipeline 134 (e.g., custom operations performed to supplement processing performed for operation of the graphics processing pipeline 134). An application 126 or other software executing on the processor(s) 102 transmits programs (often referred to as “compute shader programs,” which may be compiled by the drivers 122) that define such computation tasks to the APD 116 for execution. Although the APD 116 is illustrated with a graphics processing pipeline 134, the teachings of the present disclosure are also applicable for an APD 116 without a graphics processing pipeline 134.

As described in more detail below, the APD 116 includes a NUMA architecture and is configured to execute an application and, during execution of the application, analyze workload portions (i.e., units of execution, such as wavefronts), assess the memory access patterns for each unit of execution and map the memory access patterns between compute units and the portions of shared memory. Based on the results of the static analysis, work is scheduled during subsequent runs of the application on the APD 116 such that individual processors (e.g., compute units or SIMD units) perform more frequent memory requests to lower latency memory portions (e.g., portions of memory closest to a corresponding compute units).

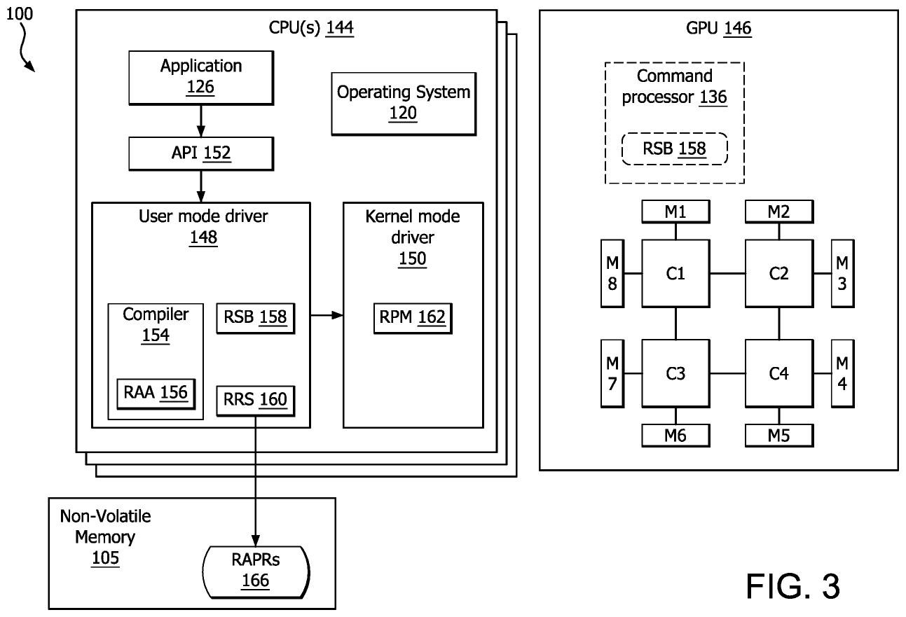

FIG. 3 is a block diagram of the computing device shown in FIGS. 1 and 2, illustrating additional details related to execution of processing tasks on the accelerated processing device, according to an example.

As shown in FIG. 3, the computing device includes one or more CPUs 144 and GPU 146. Each CPU 144 is an example of processor(s) 102 in FIG. 1 and the GPU 146 is an example of APD 116 shown in FIG. 2.

Each CPU 102 maintains, in system memory 104, one or more control logic modules for execution by the CPU 102. The control logic modules include an operating system 120, user mode driver 148 and kernel mode driver 150 and application 126, may optionally include other modules not shown. These control logic modules control various aspects of the operation of the CPU(s) 144 and the GPU 146. For example, the operating system 120 directly communicates with hardware and provides an interface to the hardware for other software executing on the CPU 144.

The user mode driver 148 includes a compiler (e.g., shader compiler) 154 that compiles instructions (e.g., shader instructions) into programs for execution by processing components (such as the SIMD units 138 discussed in further detail below) of the APD 116. The compiler 154 includes resource access assessment (RAA) component 156 which identifies the memory access patterns of the resources used by a unit of execution (e.g., work-items (i.e., threads), wavefronts, workgroup or other unit of execution). The RAA 156 receives, as input information, the shader, the number of memory portions (e.g., M1-M8) of the device 100, a number of memory pages and the format of each page used by the shader 100.

For each resource used by a program (e.g., a shader program), the RAA 156 examines the addresses of each access to the resource. For each access to the resource where the address can be calculated by tracing the arithmetic operations through the program as an absolute offset from the beginning address of a region in memory or non-volatile memory or storage, the RAA 156 creates an output record for the resource access that includes a resource identifier identifying the particular resource, a program identifier (e.g., shader program identifier) identifying the program which accesses the resource, and an access pattern relative to the base address for resource N (i.e., a pattern representing each address, relative to a starting address in memory or storage, which is accessed for the resource). The output record for the resource is, for example, stored in a resource access pattern record (RAPR) 166. As shown in FIG. 3, RAPR 166 is stored in non-volatile memory 105 to facilitate placement of resources during subsequent runs of an application. However, RAPRs 166 can be stored in any portion of memory, including volatile memory. An example RAPR is shown below in Table 1.

TABLE 1
Resource Access Pattern Record (RAPR)

Resource identifier N
Shader identifier M
Access pattern relative to base address for resource N

The access pattern can be specified through a variety of details, such as for example: the number of bytes accessed per GPU unit of execution (where a “unit of execution” or “execution unit” comprises some element of a program that can be executed, such as, e.g., work-items (i.e., threads), wavefronts, workgroup or other unit of execution), and/or the offset from the starting address of a resource base address for both beginning and end address of the page access by the unit of execution. The offset can be specified as a function f(x) where x is a unit of execution (e.g., workgroup ID in the case of a compute shader, screen space relative coordinates in the case of a pixel shader, or another type of identifier). In other words, the offset can be associated with a particular unit of execution. Thus, in some examples, the access pattern associates an identifier for a unit of execution with a resource identifier and an offset within a resource. Thus, the access pattern specifies what portion of a resource is accessed by a particular unit of execution.

In an example, the RAA 156 determines a memory portion mapping for each page given the different access patterns for each resource.

The user mode driver 148 also includes resource shader binding profiler (RSB) 158 and resource record storage manager (RRS) 160.

RSB 158 identifies which resources are bound to different units of execution (e.g., wavefront, shader program or other unit of execution). In some APIs the association is straightforward, because the API requires that association to be specified when draws and dispatches are issued. In other words, some APIs require specification of a unit of execution and one or more resources that are bound to that unit of execution. Thus, where such APIs are used, the RSB 158 is able to easily detect the association between units of execution and resources by examining the calls made to that API. However, in other APIs, the RSB 158 identifies such an association by performing profiling, because the user mode driver 148 driver does not know the association via API parameters. For these APIs, the RSB 158 performs explicit profiling operations, and records the shader identifier (or identifier of other unit of execution) associated with each page. This RSB 158 is able to observe which units of execution make accesses to which pages, and, by understanding which pages belong to which resource, is able to associate units of execution with resources and with individual items of data within each resource. This association information is then updated in the RAPRs 166. The RSB 158 is implemented, for example, as software (e.g., a module in an API) or as firmware or fixed function hardware running on command processor 136 (as shown in dashed lines in FIG. 3). RRS 160 manages the storage of resource records in non-volatile memory or storage so that information about the application can be preserved across runs of the application.

Kernel mode driver 150 controls operation of the GPU 146, for example, via API 152 to software (e.g., applications 126) executing on the CPU(s) 144 and via user mode driver 148 to access various functionality of the GPU 146. Kernel mode driver 150 includes a resource page mapping (RPM) 162 component which uses the access patterns specified in the RAPRs 166 by the RAA 156 for each resource and determines the assigning of physical pages that have different access characteristics across different processor sets (e.g., C1-C4) of the GPU 146 to hold the resource while improving access times for the majority of page accesses. RPM 162 can allow either the default execution unit scheduling mode (i.e., policy) for an application, or it can request a non-default scheduling mode for further improvements in typical access times.

In an example, a default execution unit scheduling policy includes scheduling units of execution (e.g., work-items) in any technically feasible manner which does not take into account the recorded memory access patterns associating units of execution with resources and addresses within such resources. In an example, a default execution policy includes scheduling work-items (which are units of execution) to any available SIMD unit 138. In a different scheduling policy, the RPM 162 takes into account the recorded associations between units of execution and resources, and schedules units of execution such that more work-items are executed on compute units which are located closer to memory portions accessed by those compute units than are located on compute units which are located further from such memory portions.

GPU 146 is an example of APD 116 shown in FIG. 2. FIG. 3 shows an example of NUMA architecture of GPU 146 having a cluster of 4 processors (e.g., compute units 132) and 8 local memory portions (M1-M8). Each portion of memory (M1-M8) is, for example, cache memory (e.g., L1 cache, L2 cache or L3 cache) or other type of local data storage sharable by multiple compute units.

Features of the present disclosure described herein use a memory management structure in which each local memory portion (e.g., M1-M8) is configured to store one or more pages of data. Each page is an addressable fixed-length contiguous region of memory (e.g., addressable region of local memory portions M1-M8). Each page includes addressable memory sub-regions which store sub-portions of data and are addressable via values offset from a starting address of a page. However, features of the present disclosure can be implemented using other portions of memory other than pages.

The number of processors and local memory portions shown in FIG. 3 is merely an example. Features of the present disclosure can be implemented using a NUMA architecture having any number of processors and local memory portions. In addition, the grid-like orientation of the processors and local memory portions shown in FIG. 3 is merely an example. For example, each of the processors and local memory portions can be linearly arranged (e.g., in a row).

The local memory portions M1-M8 are shared by the 4 processor sets C1-C4. However, the memory access latency (i.e., a time from when a processor set C1-C4 requests access to memory to a time when data in the local memory portion M1-M8 is returned to the processor set) and bandwidth for each processor set C1-C4 are not uniform and depend on the location of the local memory portion M1-M8 relative to a processor set C1-C4. That is, variable latency is induced by the differing amount of logic and lengths of connectivity between a set of processors and different local memory portions M1-M8. Accordingly, when memory access latency is longer for some memory accesses than others, it reduces the performance of the GPU and computing device 100.

For example, the memory access latency for processor set C1 is less when accessing data in local memory portion M1 than the memory access latency for processor set C1 when accessing data in local memory portion M5. When the memory access latency is longer for some memory accesses than others, the overall performance of the device 100 is reduced.

Features of the present disclosure determine an efficient execution of an application on a computing device having GPU NUMA architecture (hereinafter “GPU NUMA device”), by performing a static analysis during an initial run of the application. The static analysis is performed by analyzing individual GPU workload portions (i.e., units of execution, such as wavefronts), assessing the memory access patterns (which pages of data are accessed by each compute unit) for each unit of execution and mapping the memory access patterns between compute units and the portions of shared memory. Based on the results of the static analysis, work is scheduled for subsequent runs of the application on the GPU NUMA device such that individual processors (e.g., compute units) perform more frequent memory requests to lower latency memory portions (e.g., portions of memory closest to a corresponding compute units).

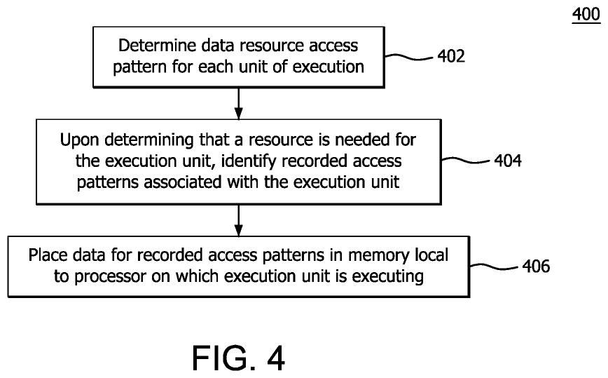

FIG. 4 is a flow diagram illustrating an example method 400 of analyzing execution of an application on a computing device comprising a GPU having a NUMA architecture. For simplified explanation, in the example method 400 described below, the accelerated processing device is a GPU. However, the method 400 described below can be implemented on any accelerated processor or accelerated processing device in which multiple processors tasks are processed in parallel (e.g., massively parallel processing) to speed up execution of the application. Although described with respect to a particular system, it should be understood that any system configured to perform the operations of the method 400 in any technically feasible order falls within the scope of the present disclosure.

As shown in FIG. 4, At step 402, the RAA 155 determines the resource access patterns for each of one or more execution units. It is possible to determine such patterns statically or dynamically. Static analysis is performed for accesses that can be known at compile time and dynamic analysis is performed for accesses that cannot be known at compile time.

Regarding accesses that can be known at compile time, at compilation time of an application (or execution unit such as a shader program, for which multiple work-items or wavefronts are executed), source code is translated, by the CPU, into executable instructions that can be executed by the GPU. The instructions refer to resources as well as offsets within the resources. In other words, instructions can specify a resource to access as well as a location (offset) within the resource to access. Thus, the resource ID and offset within a resource for memory accesses performed by instructions can be known at compilation time.

Again, in an example, a first processor (e.g., CPU 144) identifies, via RAA 156, the memory access patterns for each page used by the shader. The RAA 156 receives, as input information, the shader, the number of memory portions (e.g., M1-M8) of the device 100, a number of memory pages and the format of each memory page used by the shader 100.

For each access to the resource where the address can be calculated by tracing the arithmetic operations through the program as an absolute offset from the beginning address of a region in memory (or a region in non-volatile memory or storage), the RAA 156 creates an output record for the resource access that includes a resource identifier identifying the particular resource, a program identifier (e.g., shader program identifier) identifying the program which accesses the resource, and an access pattern relative to the base address for resource N (i.e., a pattern representing each address, relative to a starting address in memory or storage, which is accessed for the resource). The output record for the resource is, for example, stored in a resource access pattern record (RAPR) 166.

For accesses that are not possible to determine through static analysis, the RAA 156 monitors accesses made by execution units. More specifically, the RAA 156 identifies which resources and which offsets within such resources are accessed by an execution unit that is currently running and records such accesses as an output record. The RAA 156 places such output record in a resource access pattern record 166 in a similar manner as with patterns of access determined through static analysis.

At step 404, the RPM 162 identifies the access patterns for the execution unit. Again, these access patterns are stored as RAPRs 166 which are associated with particular execution units. For patterns that can be determined through static analysis, the patterns that are identified can be generated for the same instance of execution of the execution unit for which the patterns are used (e.g., in steps 404 and 406), while for dynamically accessed patterns, the RPM 162 RPM 162 can identify such patterns and use them for a subsequent instance of execution. In other words, it is possible to statically analyze an execution unit to determine access patterns and then use those access patterns for that same execution unit. At step 406, the RPM 162 causes the execution unit to be scheduled in a particular processor (e.g., processor set of FIG. 3) and causes the resources accessed by that execution unit to be loaded into a memory local to that processor. Some resources include multiple pages or cache lines (“unit of data”), and each such unit of data can be individually located in different local memories. Thus, a resource can be spread across multiple local memories. Where possible, the RPM 162 schedules execution units in processor sets that are local to units of data that are determined to be used by such execution units. It is possible for conflicts to occur (e.g., a unit of data is used by multiple execution units that are in different processor sets). In such cases, the RPM 162 is free to ignore the directive to store resources in memories that are local to the processor sets that use those resources according to the RAPRs 166.

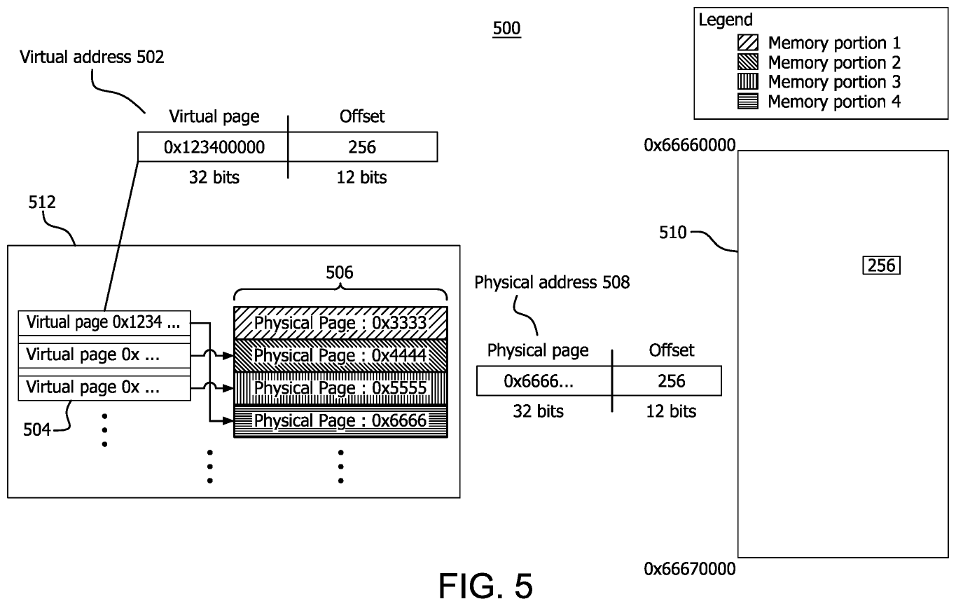

FIG. 5 is a diagram 500 showing an example of accessing a page of memory by a unit of execution (e.g., a wavefront). It should be noted that the local memory portions M1-M8 are not necessarily address by physical address and may include virtually tagged caches, in which case address translation does not need to occur. FIG. 5 illustrates situations in which the local memory portions M1-M8 are accessed via physical addresses and thus utilize address translation.

Data is stored in a local memory portion M1-M8. When a unit of execution requests access to data in one of the local memory portions M1-M8 and the request specifies a virtual address, the virtual address is mapped to the physical address of memory where the data is stored. For example, as shown in FIG. 5, the virtual address 502 provided by a unit of execution includes a 32 bit virtual page value (0x123400000) and an offset value (256).

A portion of example mappings between virtual addresses to physical addresses is shown in page table 512. As shown, a plurality of virtual page values 504 are mapped to a plurality of physical page values 506. In the example shown in FIG. 5, the virtual page value 0x1234 of virtual address 502 is mapped to physical page value 0x66660000 (i.e., starting address of the physical page) and other virtual page values 504 are mapped to other physical page values 506.

To access the data stored in a physical page 510 (in one of the local memory portions M1-M8), the virtual address 502 is translated into physical address 508 using the mapping between the virtual page address to the physical page address in the page table 512. That is, virtual address 0x123400000 with an offset value 256 is translated into physical page address 508 as address 0x666600000. The data is then accessed in page 0x66660000, at the address identified by the physical page value 0x6666 and the offset value 256.

During a first execution of the application, the memory access patterns (i.e., which physical pages of data in local memory portions M1-M8 are accessed by each processor set C1-C4) are determined for each unit of execution (e.g., (wavefront, workgroup or another unit of execution). The access patterns can be specified for example by: (1) the number of bytes accessed per workload unit of execution; and (2) the offset from the starting address of a resource base address for both the beginning address and end address of the page accessed for a unit of execution. The offset can be specified as a function f(x) where x is a unit of execution (e.g., workgroup ID in the case of a compute shader, screen space relative coordinates in the case of a pixel shader, or another type of identifier).

In some cases, a default execution unit scheduling mode (policy) is used to schedule a units of execution. For example, a default execution unit scheduling mode is used when each portion of data used for the wavefront fits into memory portions closest to a processor set used to execute the wavefront (e.g., the data fits into local memory portions M1 and M8 closest to processor set C1). In this case, the wavefront is scheduled to be executed on processor set C1 such that processor set C1 performs more frequent memory requests to local memory portions M1 and M8 with lower latency than memory requests to other local memory portions (e.g., M2-M7) with higher latency.

Alternatively, a non-default scheduling mode can be used to schedule units of execution such that more wavefronts are executed on one or more processor sets which are located closer to memory portions accessed by those one or more processor sets. For example, in some cases, some of the data for the resources used to execute a wavefront does not fit into the memory portions closest to the processor set used to execute the wavefront (e.g., the data does not fit into local memory portions M1 and M8 closest to processor set C1). In this case, the overflow data (e.g., due to oversubscribed memory) is instead stored in one or more other memory portions. For example, the overflow data that does not fit into local memory portions M1 and M8 is stored in one or more other memory portions (e.g., stored in memory portion M2) and the wavefront is scheduled to be executed on processor set C1 (closest to memory portions M1 and M8) and processor set C2 (closest to memory portion M2). Accordingly, the wavefront is executed more efficiently because processor sets C1 and C2 cumulatively perform more frequent memory requests to local memory portions M1, M8 and M2 with lower latency than memory requests to other local memory portions with higher latency (e.g., M4-M7). The non-default scheduling mode described above is merely an example. A non-default scheduling mode can also include other types of scheduling in which units of execution are not scheduled sequentially across each processor set.

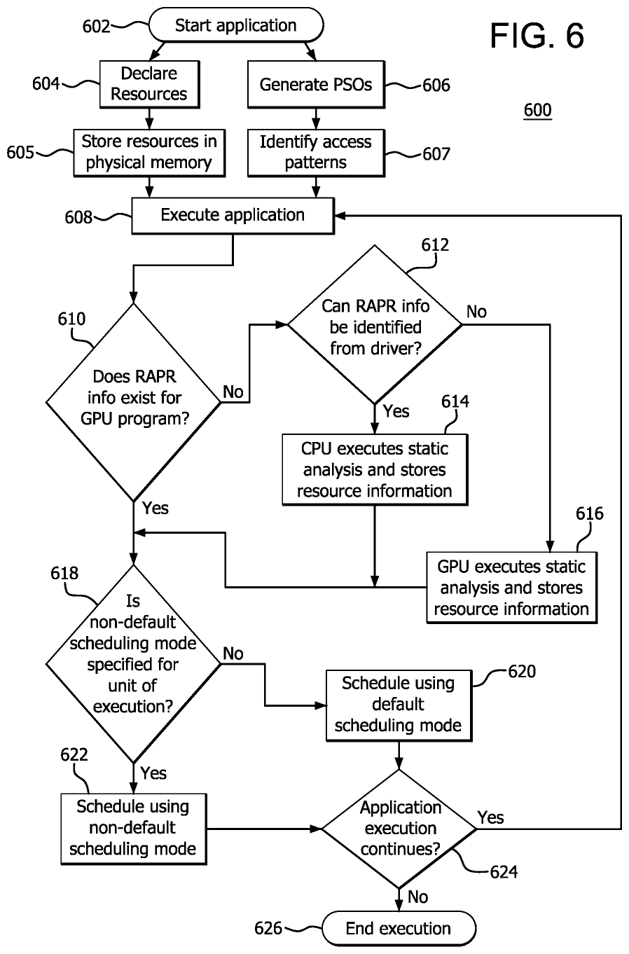

FIG. 6 is a flow diagram illustrating an example method 600 of analyzing execution of an application on computing device 100 comprising a GPU 146 having a NUMA architecture.

The application is started at block 602. At startup of an application, the application will issue requests to compile GPU programs (shader programs). At this time, source code is translated, by the CPU, into executable instructions that can be used to execute the GPU program portions (shader programs) of the application later on the GPU.

Resources are declared at block 604 and the declared resources are then allocated to or stored in physical memory (e.g., in local physical memory portions M1-M8) at block 605. FIG. 6 illustrates blocks 604 and 605 being performed at compilation time for simplified explanation. However, blocks 604 and 605 can be performed prior to compilation time, at compilation time or after compilation time. Resources can be stored in volatile memory (e.g., RAM) as well as non-volatile memory (e.g., a hard disk).

PSOs are generated, at block 606, for each program (e.g., shader program) used to execute the application and access patterns are identified at block 607. The CPU (e.g., in conjunction with the GPU) generates a pipeline state object (PSO) at compilation time, which comprises the configuration information used by the GPU to execute an application (e.g., shader program). The PSO is a description of the GPU state information (e.g. which shader is used, which resources are bound, how to perform sampling (filtering type, LOD, and the like), scissoring settings, depth settings, stencil settings, and the like) used by the GPU to execute the shader. It should be understood that the generate PSOs 606 step is not necessarily always used, for example where the operations are not graphics operations. In general, step 607 identifies access patterns statically from the code to be executed, whether or not performed with graphics operations.

In some examples, block 606 and block 607 are both performed at compilation time. Blocks 606 and 607 can also be performed prior to performing blocks 604 and 605, in parallel with performing blocks 604 and 605, or after performing blocks 604 and 605.

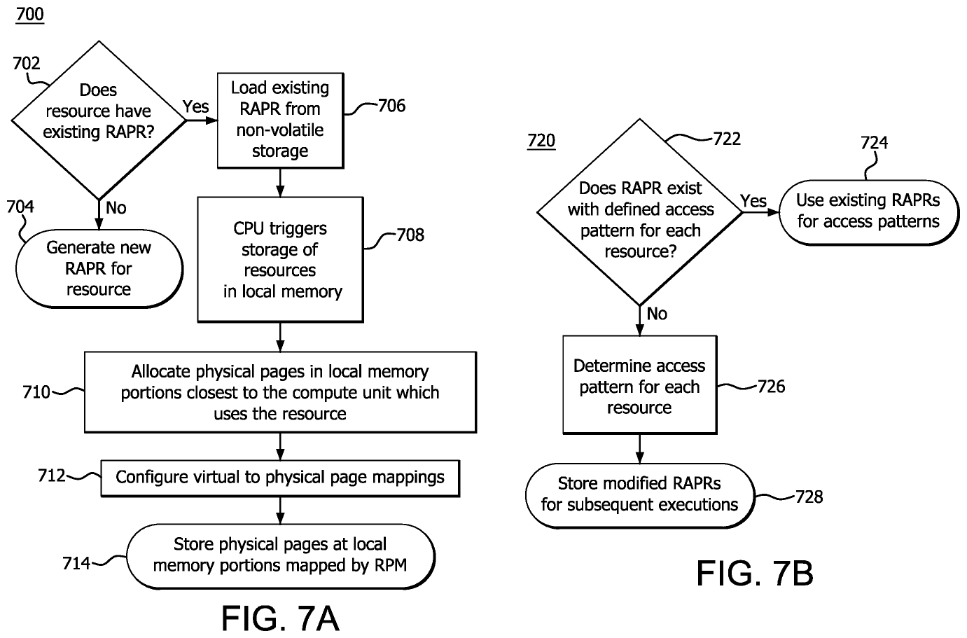

Referring momentarily to FIG. 7A, FIG. 7A is a flow diagram illustrating a method of storing resources in memory shown at block 605 with additional detail. Each of the functions performed at blocks 702-714 of method 700 are performed by a CPU (e.g., CPU 144).

As shown at decision block 702, a determination is made for each resource as to whether or not an RAPR exists (e.g., stored in non-volatile memory 105) for that particular resource.

On a condition that an RAPR does not exist for a resource (No decision), a new RAPR is generated for the resource, at block 704, and the RAPR for the resource is stored (e.g., non-volatile memory 105). On a condition that an RAPR does exist for the resource (Yes decision), the existing RAPR is loaded from non-volatile memory or storage at block 706.

In some examples, storage of each of the resources in local memory is triggered by CPU 144 (e.g., triggered by a memory managing component of OS 120). Block 708 is shown in FIG. 7A as occurring after an existing RAPR is loaded from non-volatile memory or storage at block 706. However, triggering of storage of each of the resources in local memory can occur prior to determining whether RAPRs exist for any of the resources and loading any of the resources from non-volatile memory or storage.

At block 710, physical pages are allocated in local memory portions closest to the compute unit which uses the resource. For example, if an RAPR exists for a particular resource pages are allocated in local memory potions M1-M8 for that resource.

At block 712, virtual to physical page mappings are configured. For example, as described above, kernel mode driver 150 includes a resource page mapping (RPM) 162 component which uses the access patterns specified in the RAPRs 166 by the RAA 156 for each page and determines the assigning of physical pages that have different access characteristics across different processor sets (e.g., C1-C4) of the GPU 146 to hold the resource while allowing access times for the majority of page accesses. RPM 162 can allow either the default execution unit scheduling scheme (i.e., policy) for an application, or it can request non-default scheduling policies that can allow for even further improvements in typical access times. At block 714, virtual physical pages are stored at local memory portions M1-M8 that are mapped by RPM 162.

FIG. 7B is a flow diagram illustrating an example method 700 of identifying access patterns shown at block 607 with additional detail. Each of the functions performed at blocks 722-726 of method 720 are performed by a CPU (e.g., CPU 144).

As shown at decision block 722, a determination is made, for each resource, whether or not an RAPR exists with a defined access pattern for the resource. On a condition that an RAPR with a defined access pattern does not exist for a resource (No decision), an access pattern is determined for each resource at block 726 and the newly determined (e.g., modified) RAPRs are stored for subsequent executions of the application at block 728. On a condition that an RAPR with a defined access pattern does exist for a resource (Yes decision), the existing RAPR is used for the access pattern of the resource at block 724.

Referring back to FIG. 6, at block 608, the application begins executing the application. For example, the GPU begins executing programs (e.g., shader programs involved in executing a draw).

Blocks 610-622 are then performed for each resource accessed to execute a unit of execution (e.g., a wavefront, a shader program or other unit of execution) of the application.

At decision block 610, for a resource accessed to execute a unit of execution, a determination is made as to whether or not RAPR information exists for the unit of execution (e.g., a wavefront, shader program or other portion) of the application.

On a condition that RAPR information does not exist for the unit of execution (No decision), the method proceeds to decision block 612 to determine whether or not RAPR info can be identified from the GPU driver. That is, a particular application may, or may not, specify RAPR information for execution on a GPU. Blocks 612-616 allow for flexibility for execution on applications that do specify RAPR information and applications that do specify RAPR information. On a condition that RAPR info can be identified from the GPU driver (Yes decision), the CPU executes a static analysis of the unit of execution and stores the resource information at block 614. On a condition that RAPR info cannot be identified from the GPU driver (No decision), the GPU (not the CPU) executes the static analysis of the unit of execution and stores resource binding information at block 616.

The method 600 then proceeds to decision block 618 to determine whether or not a non-default scheduling mode is specified for the unit of execution.

Referring back to decision block 610, on a condition that RAPR information does exist for the unit of execution (Yes decision), the method proceeds directly to decision block 618 to determine whether or not a non-default scheduling mode is specified for the unit of execution.

As described above, a default execution unit scheduling mode (policy) can include scheduling units of execution (e.g., wavefronts) sequentially across each processor set, such as scheduling groups of work-items to a particular processor before scheduling groups of work-items on another processor. Alternatively, a non-default scheduling mode can be used to scheduling units of execution such that more wavefronts are executed on one or more processor sets which are located closer to memory portions accessed by those one or more processor sets.

For example, in some cases, each portion of data used for a unit of execution (e.g., a wavefront) fits into memory portions (e.g., local memory portions M1 and M8) closest to a processor set (e.g., processor set C1) used to execute the wavefront. In this case, a default scheduling mode is specified for the wavefront (No decision), and the wavefront is scheduled to be executed on processor set C1 using the default scheduling mode at block 620.

However, in other cases, some of the data used to execute a wavefront may not fit into the memory portions closest to the processor set used to execute the wavefront. In this case, the overflow data (e.g., due to oversubscribed memory) is instead stored in one or more other memory portions. For example, some data used to execute a wavefront may not fit in the memory portions M1 and M8 closest to processor set C1 and the overflow data is stored in one or more other memory portions (e.g., memory portion M2). In this case, a non-default scheduling mode is specified for the wavefront (Yes decision), and the wavefront is scheduled to be executed on processor set C1 (closest to memory portions M1 and M8 and processor set C2 closest to memory portion M2) using the non-default scheduling mode at block 622.

At decision block 624, a determination is made as to whether or not execution of the application should continue. That is, a determination is made as to whether or not another unit of execution is to be executed. On a condition that another unit of execution is to be executed (Yes decision), the method proceeds back to block 608 and blocks 610-622 are repeated for the next unit of execution. On a condition that another unit of execution is not to be executed (No decision), the method proceeds to block 626 and the modified RAPRs are stored in non-volatile memory for use in subsequent executions of the application on the GPU.

After a static analysis is performed during a first execution of the application (e.g., blocks 402-406 of FIG. 4) on the computing device 100, the modified RAPRs stored in non-volatile memory (resulting from the static analysis performed during a first execution) can be used to execute the application on the same computing device 100 more efficiently for subsequent executions of the application.

Alternatively, after the static analysis is performed during a first execution of the application on the computing device 100, the modified RAPRs stored in non-volatile memory can also be used to execute the application more efficiently on other computing devices having the same architecture (i.e., other computing devices 100) for subsequent executions of the application on the other devices.

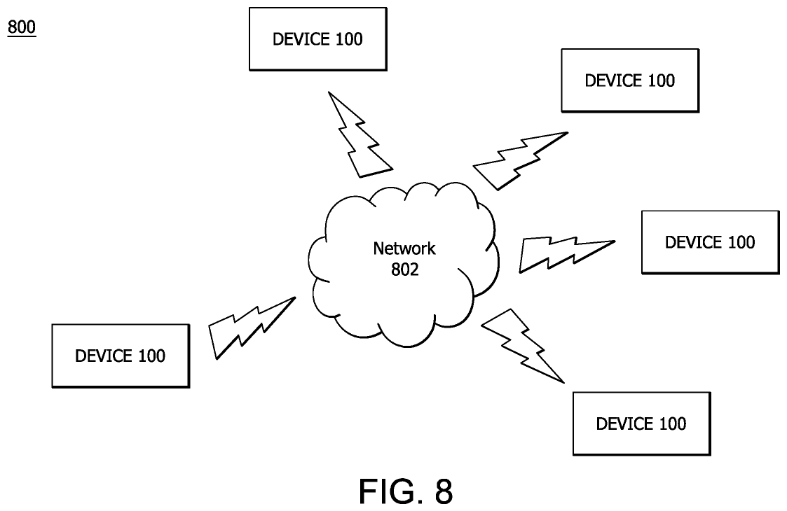

FIG. 8 is a diagram illustrating an example system 800 for analyzing execution of an application. The system 800 includes network 802 and a plurality of the same computing devices 100 in communication with each other via the network 802. Each computing device 100 comprises GPU 146 having the NUMA architecture shown in FIG. 3 (e.g., processor sets C1-C4 and shared local memory portions M1-M8) and one or more CPUs 144. Network 802 is for example a wired network, a wireless network, or a combination of one or more wired and wireless networks. The number of computing devices 100 shown in FIG. 8 is merely an example. Features of the present disclosure can be implemented in a system comprising any number of computing devices 100 in communication with each other via network 802.

After the static analysis is performed during a first execution of the application on any one of the computing devices 100, the modified RAPRs stored in non-volatile memory can be sent over the network 802 to one or more of the other computing devices 100. Then, the computing device 100 used to perform the static analysis and the one or more of the other computing devices 100 to which the modified RAPRs were sent can execute the application more efficiently using the modified RAPRs.

In an alternative example, page migration can be performed after a static analysis is performed for a unit of execution and the resource information is stored (e.g., by CPU at block 614 or by GPU at block 616). For example, after a static analysis is performed for a unit of execution and the resource information is stored, on a condition that it is determined that physical page 0x666600000 (shown in FIG. 5) in local memory portion M1 should instead be in local memory portion M4, a page of memory is allocated in local memory portion M4, the data in physical page 0x666600000 is copied into a new physical page in local memory portion M1 and the virtual page to physical page mapping is changed to map the virtual address 502 to the physical address of the new physical page in local memory portion M4.

Each of the functional units shown in the figures and/or described in the specification comprise software, hardware, or a combination thereof, as appropriate. The term software includes compute instructions, stored in volatile or non-volatile memory or any technically feasible storage medium, that are capable of execution by a programmable processor (e.g. a CPU or a GPU). The term “hardware” includes electrical circuitry configured to perform the functionality described herein. In various examples, such hardware includes a processor such as a fixed-function processor, a programmable processor, or other type of processor (e.g., CPU, GPU, microcontroller, field programmable gate array, programmable logic device, or any other type of processor, fixed-function circuitry (e.g., an application specific integrated circuit, or other type of circuitry that performs the operations described herein), or any other type of circuitry. In particular, and by way of example, the “functional units” include, without limitation, the processor(s) 102, auxiliary device(s) 106, auxiliary processor(s) 114, ADP 116, IO devices 118, ROM 140, operating system 120, driver 122, application(s) 126, APD 116, APD ROM 142, command processor 136, compute unit 132, SIMD unit 138, RSB 158, RRS 160, RAA 156, RPM 162, command processor 136, RSB 158, device 100, and network 802.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device for analyzing execution of an application, the computing device comprising:
a processor of a first type having a non-uniform memory access (NUMA) architecture comprising:
a plurality of local memory portions; and
a plurality of processor sets sharing the plurality of local memory portions and configured to execute the application as units of execution; and
a processor of a second type configured to:
issue commands to the processor of the first type to execute execution units of the application;
identify a resource access pattern for each resource accessed in one or more of the local memory portions for the units of execution; and
subsequently execute the execution units of the application, including loading resources into the local memory portions based on the identified resource access patterns.

2. The computing device of claim 1, wherein:
the subsequent execution of the execution units includes scheduling work on the plurality of processor sets such that one or more processor sets perform more frequent memory requests to the local memory portions with lower latency than memory requests to the local memory portions with higher latency.

3. The computing device of claim 1, wherein the subsequent execution of the execution units includes scheduling work on the processor sets such that each processor set performs more frequent memory requests to the local memory portions closest to a corresponding processor set than to local memory portions not closest to the corresponding processor set.

4. The computing device of claim 3, wherein, in response to each portion of data to be accessed for the unit of execution being in the local memory portions closest to one of the processor sets, the processor of the second type is configured to schedule the unit of execution to be executed on the one processor set.

5. The computing device of claim 3, wherein in response to a portion of data to be accessed for the unit of execution being in the local memory portions closest to the one processor set and another portion of data to be accessed for the unit of execution being in one or more other local memory portions closest to another one of the processor sets, the processor of the second type schedules the unit of execution to be executed on the one processor set and the other one of the processor sets.

6. The computing device of claim 1, wherein the processor of the second type is configured to determine the resource access patterns for each unit of execution.

7. The computing device of claim 1, wherein
identifying the resource access pattern for each resource comprises performing static analysis.

8. The computing device of claim 1, wherein the processor of the second type is configured to:
store the resource access patterns in non-volatile memory; and
send the resource access patterns to on one or more other computing devices via a network, and
the application is subsequently executed on the one or more other computing devices in the network based on the resource access patterns.

9. The computing device of claim 1, wherein the processor of the second type is configured to, during execution of the application:
store a resource access pattern in memory; and
for a unit of execution, in response to a page of data in a first local memory portion being determined, from the resource access pattern, to be in a second local memory portion different than a first memory portion, performing page migration by copying the data from the first memory portion to the second memory portion.

10. A method of analyzing execution of an application on a computing device, the method comprising:
issuing, by a processor of a second type, commands to a processor of a first type having a non-uniform memory access (NUMA) architecture, the commands including commands to execute execution units of the application;
identifying, by the processor of the second type, a resource access pattern for each resource accessed in one or more local memory portions based on the identified resource access patterns; and
subsequently executing the execution units of the application, including loading resources into the local memory portions based on the identified resource access patterns.

11. The method of claim 10, further comprising:
the subsequent execution of the execution units includes scheduling work on the plurality of processor sets such that one or more processor sets perform more frequent memory requests to the local memory portions with lower latency than memory requests to the local memory portions with higher latency.

12. The method of claim 10, wherein the subsequent execution of the execution units includes scheduling work on the processor sets such that each processor set performs more frequent memory requests to the local memory portions closest to a corresponding processor set than to local memory portions not closest to the corresponding processor set.

13. The method of claim 12, further comprising:
in response to each portion of data to be accessed for a unit of execution being in local memory portions closest to one of the processor sets, scheduling, by the processor of the second type, the unit of execution to be executed on the one processor set.

14. The method of claim 12, further comprising:
in response to a portion of data to be accessed for the unit of execution being in the local memory portions closest to the one processor set and another portion of data to be accessed for the unit of execution being in one or more other local memory portions closest to another one of the processor sets, scheduling, by the processor of the second type, the unit of execution to be executed on the one processor set and the other one of the processor sets.

15. The method of claim 10, further comprising:
identifying the resource access pattern for each resource comprises performing static analysis.

16. The method of claim 10, further comprising:
storing, by the processor of the second type, the resource access pattern for each resource in non-volatile memory; and
sending, by the processor of the second type, the resource access pattern for each resource to on one or more other computing devices via a network,
wherein the application is subsequently executed on the one or more other computing devices in the network based on the resource access pattern for each resource.

17. The method of claim 10, further comprising:
storing, by the processor of the second type, a resource access pattern in memory; and
for a unit of execution, in response to a page of data in a first local memory portion being determined, from the resource access pattern, to be in a second local memory portion different than a first memory portion, performing page migration by:
copying the data from the first memory portion to the second memory portion;
changing a virtual page to physical page mapping; and
mapping a virtual address to a physical address of a new page in the second local memory portion.

18. A system for analyzing execution of an application, the system comprising:
a network; and
a plurality of computing devices in communication with each other via the network, each of the plurality of computing devices comprising:
a processor of a first type having a non-uniform memory access (NUMA) architecture comprising:
a plurality of local memory portions; and
a plurality of processor sets sharing the plurality of local memory portions and configured to execute the application as units of execution; and
a processor of a second type configured to:
issue commands to the processor of the first type to execute execution units of the application;
identify a resource access pattern for each resource accessed in one or more of the local memory portions for the units of execution; and
subsequently execute the execution units of the application, including loading resources into the local memory portions based on the identified resource access patterns.

19. The system of claim 18, wherein
the subsequent execution of the execution units includes scheduling work on the plurality of processor sets such that one or more processor sets perform more frequent memory requests to the local memory portions with lower latency than memory requests to the local memory portions with higher latency.

20. The system of claim 18, wherein:
the subsequent execution of the execution units includes scheduling work on the processor sets such that each processor set performs more frequent memory requests to the local memory portions closest to a corresponding processor set than to local memory portions not closest to the corresponding processor set.
